(19) United States
(12) Patent Application Publication
(10) Pub. No.: US 2023/0191542 A1
(43) Pub. Date: Jun. 22, 2023

(54) MANUFACTURING PROCESS FOR FORMING A SHARP FEATURE IN AN AXIAL SEALING FLUID TRANSPORT FITTING

(71) Applicant: Hanon Systems, Daejeon (KR)

(72) Inventors: Eric Kesler, Northville, MI (US); Salvador Guadalajara, Cd. Juarez Chih (MX); Kap-Yeol Lee, Novi, MI (US); Darren Hock, Manchester, MI (US)

(21) Appl. No.: 18/051,169

(22) Filed: Oct. 31, 2022

Related U.S. Application Data
(60) Provisional application No. 63/265,613, filed on Dec. 17, 2021.

(51) Int. Cl. B23P 9/02; F16L 19/028

(52) U.S. Cl. CPC B23P 9/025; F16L 19/028

(57) ABSTRACT

A coining apparatus for forming a sealing surface in an end portion of a tube includes an inner portion having a first bead forming surface and an outer portion having a second bead forming surface. The outer portion is arranged concentric to the inner portion with a radial gap formed therebetween. The first bead forming surface and the second bead forming surface each lead towards the gap and are tapered in opposing radial directions. The radial gap provides a pathway for a flow of deformed tube material or a flow of fluid during the formation of an engaging bead in the sealing surface as caused by engagement of the first bead forming surface and the second bead forming surface with the end portion of the tube. The formation of the engaging bead via the coining process results in at least a portion of the engaging bead being work hardened.

### CROSS-REFERENCE TO RELATED APPLICATION

This patent application claims priority to U.S. Provisional Patent Application Ser. No. 63/265,613, filed on Dec. 17, 2021, the entire disclosure of which is hereby incorporated herein by reference.

### FIELD OF THE INVENTION

The invention relates generally to an apparatus for manufacturing a sealing surface of a block fitting assembly and a method of operating the same, and more particularly, to a punch assembly configured to form a V-shaped bead in a sealing surface of a metal seal assembly of a block fitting assembly and a method of operating the same.

### BACKGROUND OF THE INVENTION

The components of a fluid system are typically joined to each other by fluid lines extending between the components. The connection of each fluid line to each respective component introduces additional points at which a fluid carried by the fluid line may leak out of the refrigerant circuit or at which exterior contaminants may undesirably be introduced into the refrigerant. The lack of a suitable seal at each fluid line connection may lead to damage to the components forming the refrigerant circuit or may reduce an operating efficiency of the refrigerant circuit.

Such fluid line connections are commonly formed between a male seal fitting block (hereinafter “the male block”) and a cooperating female seal fitting block (hereinafter “the female block”) forming a block fitting assembly. The male block and the female block may each be associated with one of a pair of components configured to communicate a fluid therethrough. The male block includes a projecting portion and the female block includes a recessed portion configured to receive the projecting portion. The projecting portion and the recessed portion include aligned flow paths that communicate the fluid therebetween, wherein one or both of the aligned flow paths may further receive a tubing segment therein associated with one of the associated components. A primary sealing element is typically compressed between the projecting portion and the recessed portion to prevent the leakage of the fluid from the aligned flow paths and/or tubing segments.

It is known to utilize a metal sealing assembly in forming such a blocking fitting assembly. A metal sealing assembly includes a sealing element having a metallic portion that is compressed between a first bead projecting axially from the male block and a second bead projecting axially from the female block. Each of the beads may include a V-shaped cross-section in order to minimize the contact area present between the blocks and the metallic portion of the sealing element, thereby facilitating improved deformation of the metallic portion of the sealing element at the positions where the beads first engage the metallic portion during compression thereof. The deformation of the metallic portion of the sealing element results in a fluid tight seal being formed along the areas of engagement present between the metallic portion and each of the oppositely arranged beads. Examples of such metal sealing assemblies may be found in U.S. Pat. Nos. 8,468,849, 9,261,194, and 9,556,993, each of which is hereby incorporated herein by reference in its entirety. Such a metal seal assembly may include the V-shaped beads being formed to include a maximized sharpness, which corresponds to a radius of curvature of each of the point ends of the V-shape having a radius of curvature approaching zero. As the radius of curvature approaches zero, the initial contact surface area of the corresponding bead is minimized, which results in an increase in pressure applied by the correspond bead when first contacting the metallic portion of the sealing element.

One possible configuration of the metal seal assembly includes one of the tube segments associated with one of the block fittings being formed into a sealing surface having one of the aforementioned V-shaped beads formed therein. For example, one method of forming such a tube segment into a sealing surface may first include feeding the tube through an opening formed through a block until an end portion of the tube extends axially beyond a distal arranged surface of the block. This end portion of the tube is then flanged radially outwardly to engage a surface of the block arranged perpendicular to the axial direction of the tube, wherein this radial outward flaring of the end portion may be accomplished by a suitable punching operation. As a final step, a sealing surface including at least one of the V-shaped beads is machined into the exposed axial end surface of the flanged portion of the tube. The formation of the sealing surface at an axial end portion of the tube results in the sealing surface being positioned to engage an annular sealing element when the illustrated block is operably coupled to a mating block, wherein the mating block includes an oppositely arranged V-shaped bead to cooperate with the V-shaped bead formed in the tube end portion. The tube fed through the block may include a variable thickness or configuration along the length thereof to achieve the desired configuration of the resulting flanged portion and V-shaped bead according to the steps proposed above.

One disadvantage of the described manufacturing process relates to the manner in which the final machining process for contouring the sealing surface is especially complex and difficult to achieve in comparison to the previously occurring forming (punching) steps. The machining may be performed by a rotating cutting tool that is subject to machine runout during the cutting process. This machine runout can lead to a radial offsetting of the inclined surfaces forming the V-shaped bead, which can in turn lead to a V-shaped bead having a reduced height and a flattened, rather than sharpened, distal surface. The machining process used to create the sealing surface accordingly requires a high amount of attention and preventative maintenance.

It has been proposed to utilize a similar punching process to form the sealing surface in the flanged portion to avoid the above-described concerns relating to the rotational machining process. However, it has been discovered that the variable shape of the sealing surface and the manner in which the flanged portion is compressed axially against the corresponding punching tool can result in gases and/or oil present during the manufacturing process being entrapped between the sealing surface of the flanged portion and the engaging surface of the punching tool. This entrapped gas and/or oil can result in surface irregularities forming in the sealing surface that lower the sealing effectiveness thereof due to the resulting surface roughness of the sealing surface.

It would accordingly be desirable to manufacture a sealing surface into a tube segment of a block fitting assembly using a punching or coining operation that avoids the entrapment of gas and/or oil during the deformation of the tube segment into the sealing surface.

### SUMMARY OF THE INVENTION

Compatible and attuned with the present invention, an apparatus for forming a sealing surface in an end portion of the tube of a block fitting has surprisingly been discovered.

According to an embodiment of the present invention, a coining apparatus includes an inner portion including an outer circumferential surface. The outer circumferential surface includes a first outer axially extending surface and a first bead forming surface intersecting the first outer axially extending surface. The first bead forming surface is tapered inwardly towards a central axis of the inner portion as the first bead forming surface extends away from the first outer axially extending surface. The inner portion is configured to be movable axially towards the end portion of the tube for forming a first inclined surface of the engaging bead via a deformation of the end portion of the tube by the first bead forming surface. An outer portion includes an inner circumferential surface including an inner axially extending surface and a second bead forming surface intersecting the inner axially extending surface. The first bead forming surface is tapered outwardly away from the central axis of the inner portion as the second bead forming surface extends away from the inner axially extending surface. The outer portion is configured to be movable axially towards the end portion of the tube for forming a second inclined surface of the engaging bead via a deformation of the end portion of the tube by the second bead forming surface. The first outer axially extending surface of the inner portion faces outwardly towards the inner axially extending surface of the outer portion with a radially extending gap present therebetween.

A method of coining an engaging bead into an end portion of a tube is also disclosed according to the present invention. The method comprises a step of providing a coining apparatus comprising an inner portion and an outer portion, the inner portion including an outer circumferential surface, the outer circumferential surface including a first outer axially extending surface and a first bead forming surface intersecting the first outer axially extending surface, wherein the first bead forming surface is tapered inwardly towards a central axis of the inner portion as the first bead forming surface extends away from the first outer axially extending surface; the outer portion including an inner circumferential surface including an inner axially extending surface and a second bead forming surface intersecting the inner axially extending surface, wherein the first bead forming surface is tapered outwardly away from the central axis of the inner portion as the second bead forming surface extends away from the inner axially extending surface, wherein the first outer axially extending surface of the inner portion faces outwardly towards the inner axially extending surface of the outer portion with a radially extending gap present therebetween; deforming the end portion of the tube to include a first inclined surface of the engaging bead when the inner portion is moved axially towards the end portion of the tube with the first bead forming surface engaging the end portion of the tube; and deforming the end portion of the tube to include a second inclined surface of the engaging bead when the outer portion is moved axially towards the end portion of the tube with the second bead forming surface engaging the end portion of the tube.

According to another embodiment of the present invention, a block seal fitting assembly is disclosed. The block seal fitting assembly includes a first block having a first opening formed therethrough, a sealing element, and a tube extending through the first opening of the first block. An end portion of the tube forms a seal engaging surface of the tube configured to sealingly engage the sealing element. The seal engaging surface includes an annular engaging bead projecting axially therefrom with the engaging bead extending around a flow opening formed through the tube at the end portion thereof. At least a portion of the engaging bead is work hardened by a coining process used to form the engaging bead in the end portion of the tube.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings of which:

FIG. 1 is an exploded cross-sectional elevational view of a block seal fitting assembly according to an embodiment of the present invention;

FIG. 2 is a cross-sectional elevational view illustrating a lift angle of a first segment of a tube relative to a second segment of the tube when the first segment of the tube is received within a first block;

FIG. 3 is a bottom plan view of the first block illustrating a range of angular orientations for the second segment of the tube relative to the first segment of the tube;

FIG. 4 is a cross-sectional elevational view of the block seal fitting assembly of FIG. 1 when the first block and a second block are coupled to each other to compress a sealing element therebetween;

FIG. 5 is an exploded cross-sectional elevational view showing a tube following a bending thereof and prior to reception within the first block;

FIG. 6 is a cross-sectional elevational view illustrating a tube end forming apparatus suitable for performing a first deforming step on an end portion of the tube;

FIG. 7 is a cross-sectional elevational view illustrating a second deforming step performed on the end portion of the tube;

FIG. 8 is a cross-sectional elevational view illustrating the first block and the tube following the first and second deforming steps of FIGS. 6 and 7;

FIG. 9 is a cross-sectional elevational view illustrating an apparatus for coining a sealing surface into a tube of a block seal fitting assembly according to an embodiment of the present invention;

FIG. 10 is a perspective view of an inner portion of the apparatus of FIG. 9;

FIG. 11 illustrates a profile shape of an exemplary relief notch for inclusion in the inner portion of the apparatus of FIG. 9;

FIG. 12 is an enlarged fragmentary view showing a positioning of the inner portion and an outer portion of the apparatus of FIG. 9 relative to a first block and a tube end portion prior to a deformation of the tube end portion via the apparatus;

FIG. 13 is an enlarged fragmentary view showing a positioning of the inner portion and the outer portion following reception of the inner portion within the tube and engagement of the outer portion with the tube end portion;

FIG. 14 is an enlarged fragmentary view showing a positioning of the inner portion and the outer portion following engagement of each of the inner portion and the outer portion with the tube end portion;

FIG. 15 is a chart showing a preferred gap distance between the inner and outer portions of the apparatus for forming a desired bead based on a temper of the tube being deformed by the inner and outer portions;

FIG. 16 is a chart showing a preferred gap distance between the inner and outer portions of the apparatus for forming a desired bead based on a viscosity of an oil utilized during operation of the apparatus that may be disposed between the inner and outer portions and the tube end portion during the deformation of the tube end portion;

FIGS. 17 and 18 illustrate alternative embodiments of the invention which may be formed using the apparatus of FIG. 9 following prior manufacturing steps for forming modified projecting portions of the first block.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

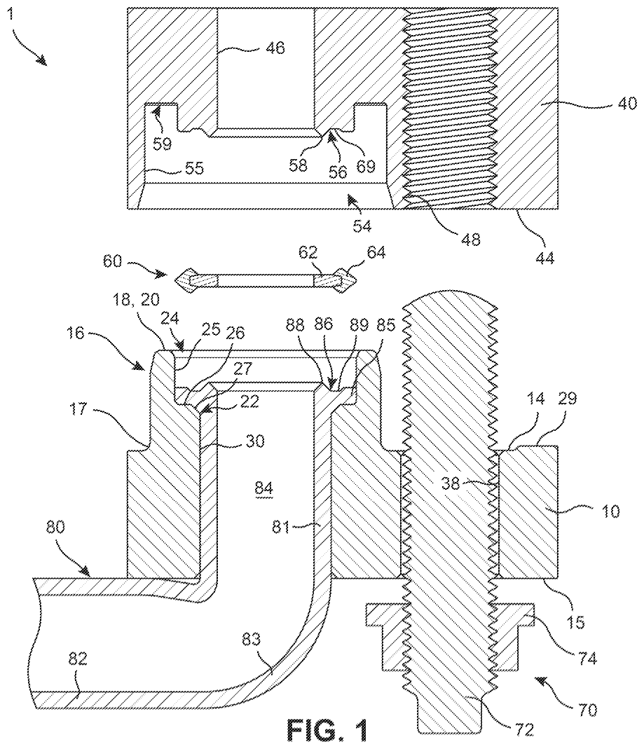

FIG. 1 illustrates a block seal fitting assembly 1 as may be produced using the apparatus and method described hereinafter according to an embodiment of the present invention. The general features of the block assembly 1 relevant to the operation of the disclosed method and apparatus are described herein for context when describing the manufacturing process according to the present invention. The block assembly 1 may be used to couple two different components to each other wherein a fluid associated with the two components enters or exits one of the components with a different flow orientation than when the fluid enters or exits the other of the components. In all cases, the two components may be any two components associated with any type of fluid conveying system, such as an HVAC system, a cooling system, a hydrogen fuel cell system, a steering system, or a braking system of a motor vehicle, as non-limiting examples. The block assembly 1 may be subjected to any type of fluid, including glycol, water, ethanol, methanol, gasoline, diesel, jet fuel, various types of refrigerants or coolants, or combinations thereof, as non-limiting examples.

The block assembly 1 includes a first block 10, a second block 40, a sealing element 60, a fastener assembly 70, and a tube 80. As shown, the first block 10 forms a male component and the second block 40 forms a female component of the block assembly 1. The first block 10 and the second block 40 are each formed of a rigid material. The rigid material may be a metallic material such as aluminum, steel, and alloys thereof. The tube 80 may be formed from the same materials suitable for forming the blocks 10, 40. In some embodiments, each of the blocks 10, 40 and the tube 80 are formed from a common material, as desired. In some embodiments, the blocks 10, 40 are formed from a different material than the tube 80.

The first block 10 includes a main body having a substantially planar first mating face 14 and a projecting portion 16 extending substantially perpendicularly from the first mating face 14. The projecting portion 16 may include a substantially cylindrical outer surface, but other configurations of the outer surface of the projecting 16 may also be utilized such as a hexagonal outer surface configuration, as desired. The projecting portion 16 includes a first end 17 intersecting the first mating face 14 and a second end 18 spaced from the first mating face 14 in an axial direction of the projecting portion 16. The second end 18 of the projecting portion 16 defines a piloting feature 20 of the first block 10 in the form of a peripherally extending rim of the projecting portion 16. The piloting feature 20 may be inwardly tapered to more easily guide the projecting portion 16 into a corresponding portion of the second block 40, as explained hereinbelow.

The piloting feature 20 circumscribes a substantially cylindrical first recess 24 formed in the projecting portion 16. The first recess 24 extends in the axial direction of the projecting portion 16 from the second end 18 thereof toward the first end 17 thereof. The first recess 24 is defined by an inner circumferential surface 25 and a radially extending surface 26 of the projecting portion 16. The inner circumferential surface 25 extends in the axial direction of the boss 16 from the second end 18 thereof to a position intermediate the first end 17 and the second end 18 thereof, but alternative depths of the first recess 24 may be used without departing from the scope of the present invention.

The radially extending surface 26 extends radially inwardly from the inner circumferential surface 25 towards a first opening 30 of the first block 10. The first opening 30 is cylindrical in shape and formed concentrically with respect to the first recess 24 of the projecting portion 16. The first opening 30 also extends in the axial direction of the projecting portion 16, which is perpendicular to the first mating face 14 of the first block 10. The first opening 30 extends through an entirety of the first block 10 and is configured to receive the tube 80 therein. The radially extending surface 26 and an axially extending surface defining the first opening 30 accordingly form an annular shoulder 22 spaced radially inwardly from the inner circumferential surface 25 of the projecting portion 16. The shoulder 22 may further include a chamfer 27 forming a frustoconical surface for connecting the radially extending surface 26 to the surface of the main body defining the first opening 30, as desired.

The first block 10 further includes a first fastener aperture 38 and a leverage feature 29.

The first fastener aperture 38 extends through the first block 10 and is spaced laterally from and arranged parallel to the first opening 30. The first fastener aperture 38 may be substantially cylindrical in shape and may be configured to receive a threaded fastener 72 of the fastener assembly 70. The leverage feature 29 may be formed at an end of the first mating face 14 adjacent the first fastener aperture 38. The leverage feature 29 may take the form of a fulcrum extending away from the first mating face 14 in the axial direction of the first fastener aperture 38. The leverage feature 29 may be substantially heel-like in appearance as the leverage feature 29 extends away from the first mating face 14 of the first block 10.

The tube 80 may include a first segment 81, a second segment 82, and a bend portion 83 connecting the first segment 81 to the second segment 82. A flow opening 84 extends through each of the first segment 81, the bend portion 83, and the second segment 82. The first segment 81 is substantially cylindrical in shape and extends linearly in the axial direction of the first opening 30 while the second segment 82 is substantially cylindrical in shape and extends linearly in a direction arranged at an angle greater than or equal to 0 degrees and equal to or less than 90 degrees relative to the axial direction of the first opening 30 and the first segment 81. The angle formed between the first segment 81 and the second segment 82 is hereinafter referred to as the lift angle of the tube 80. The flow opening 84 includes a substantially circular or elliptical cross-sectional shape along a length of the tube 80 to minimize a drop in pressure of the fluid when traversing the tube 80.

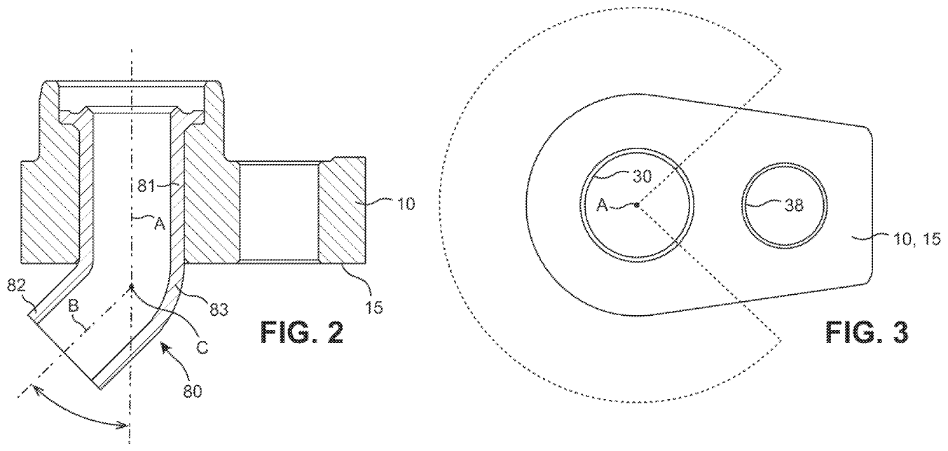

FIG. 1 illustrates the lift angle present between the first segment 81 and the second segment 82 as being about 90 degrees with the second segment 82 extending in a direction away from the fastener assembly 70 of the block assembly 1. However, as shown in FIGS. 2 and 3, the second segment 82 may have any number of possible orientations relative to the first segment 81 so long as the second segment 82 does not interfere with a portion of the block assembly 1 such as the threaded fastener 72 or a secondary component disposed adjacent the block assembly 1. The tube 80 may, for example, include no bend at all, wherein an entirety of the tube 80 extends rectilinearly.

For example, FIG. 2 illustrates an alternative lift angle of about 45 degrees present between the first segment 81 and the second segment 82 while also showing a generalized relationship between the first segment 81, the second segment 82, and the bend portion 83 of the tube 80. Regardless of the selected lift angle (except for zero), a central axis A of the first segment 81 always intersects a central axis B of the second segment 82 at a point C disposed within the bend portion 83 of the tube 80. The point C is further disposed exterior to the first opening 30 of the first block 10 and spaced from an outer face 15 of the first block 10 formed opposite the mating face 14 with respect to the axial direction of the first opening 30. The bend portion 83 also extends arcuately when connecting the first segment 81 to the second segment 82. A centerline radius of curvature of the tube 80 along the bend portion 83 is preferably substantially constant when the centerline radius of curvature connects the central axis A to the central axis B to reduce the drop in pressure of the fluid traversing the flow opening 84. The radius of curvature of the tube 80 along the bend portion 83 thereof is also preferably minimized in order to form a tight bend in the tube 80 for reducing the packaging space occupied by the tube 80 while still forming the bend portion 83 in the tube 80 at a position exterior to the first opening 30. For example, the bend portion 83 of the tube 80 in FIG. 1 includes a minimized radius of curvature in order to minimize an extent to which the second segment 82 projects away from the first block 10 in the axial direction of the first opening 30, which in turn minimizes a profile of the entire block assembly 1 in the axial direction of the first opening 30, while requiring no modification of the structure of the first opening 30 to accommodate the reception of the tube 80 therein.

FIG. 3 shows that the second segment 82 may also have a plurality of different angular orientations relative to the central axis A of the first segment 81 in addition to that shown in FIG. 1. For example, the dashed line in FIG. 3 bounds a range of potential angular orientations of the second segment 82 relative to the central axis A of the first segment 81 for a given lift angle, such as the 90 degree lift angle shown in FIG. 1, while preventing interference between the second segment 82 and the threaded fastener 72 when the threaded fastener 72 is disposed in the first fastener aperture 38 of the first block 10. As should be understood by one skilled in the art, a reduction in the lift angle will result in a greater range of potential angular orientations of the second segment 82 relative to the first segment 81 when the reduction in lift angle reorients the second segment 82 in a manner preventing interference with the threaded fastener 72. As mentioned above, the tube 80 may be purely rectilinear in configuration in the absence of the bend, hence the tube 80 may be described as having only one segment extending axially and rectilinearly.

The tube 80 is shown as including only the two segments 81, 82 separated by the single bend portion 83, but the tube 80 may include additional bends within a portion of the tube 80 extending away from the second segment 82 in order to fluidly couple the block assembly 1 to an adjacent component of the associated fluid system while accommodating the available packaging space provided by the associated fluid system. The remainder of the tube 80 not shown throughout the figures may accordingly include substantially any configuration suitable for communicating a fluid therethrough without departing from the scope of the present invention.

Referring back to FIG. 1, the first segment 81 extends longitudinally from a seal engaging portion 85 of the tube 80 disposed within the recess 24 of the projecting portion 16 to the bend portion 83 thereof. The seal engaging portion 85 is formed by an end portion of the tube 80 extending radially outwardly to cause the seal engaging portion 85 to be an outwardly extending flange of the tube 80. An underside of the seal engaging portion 85 engages and conforms in shape to the shoulder 22, the radially extending surface 26, and the inner circumferential surface 25 of the projecting portion 16 to prevent the existence of any gaps at the joint therebetween.

The seal engaging portion 85 of the tube 80 forms a first seal engaging surface 86 having at least one seal engaging bead 88 formed intermediate the inner circumferential surface 25 and the flow opening 84 formed through the tube 80. The engaging bead 88 extends annularly adjacent the first opening 30 and is configured to sealingly engage the sealing element 60. The engaging bead 88 forms an axially extending projection or rib configured to impart a localized compressive stress on a portion of the sealing element 60 disposed within the first recess 24.

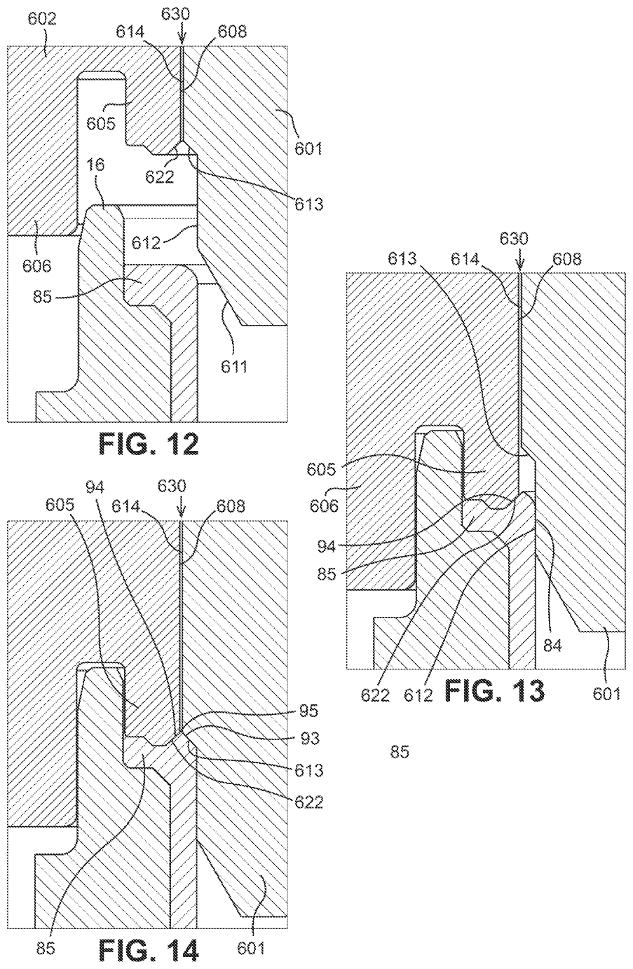

The engaging bead 88 is shown in FIG. 1 as having a substantially V-shaped cross-sectional shape including a pointed edge formed at a distal end of the engaging bead 88. The edge may be formed by a pair of tapering surfaces arranged at an angle relative to each other. A sharpness of the edge of the engaging bead 88 may be selected to impart a desired degree of compressive stress to the portion of the sealing element 60, as explained in greater detail when describing the method of formation of the engaging bead 88 with reference to FIGS. 12-14. In some embodiments, an angle formed between the cooperating surfaces forming the pointed edge may be selected to be at least 60 degrees and less than 90 degrees. In other embodiments, the angle may be greater than 90 degrees and less than or equal to 120 degrees.

In some embodiments, each of the tapered surfaces forming the engaging bead 88 may include equal and opposing angles of inclination relative to the axial direction of the opening 30 and the first segment 81 of the tube 80. For example, each of the opposing tapered surfaces may be arranged at opposing 45 degree angles of inclination such that the total angle of inclination present between the tapered surfaces equals 90 degrees. In other embodiments, it is conceivable one of the opposing tapered surfaces may have a differing angle of inclination than the other of the tapered surfaces, so long as the resulting engaging bead 88 is able to apply an axial force in a desired manner consistent with operation of the block assembly 1. One skilled in the art should appreciate that alternative and additional configurations of the engaging bead 88 may also be used without departing from the scope of the present invention, so long as the engaging bead 88 is suitable for delivering the desired localized compressive stress to the portion of the sealing element 60 disposed within the first recess 24. In some embodiments, the engaging bead 88 may be arranged radially to be disposed intermediate the surfaces defining the opening 30 and the flow opening 84, thereby aligning the pointed edge of the engaging bead 88 with an axially extending portion of the tube 80 adjacent the first seal engaging surface 86.

The first seal engaging surface 86 may further include at least one cavity 89 formed therein. The at least one cavity 89 forms a depression in the first seal engaging surface 86 indented in a direction opposing the direction of extension of each of the engaging beads 88 projecting from the first seal engaging surface 86. FIG. 1 illustrates the first seal engaging surface 86 as including a single annular cavity 89 formed adjacent and radially outwardly of the engaging bead 88. The cavity 89 is shown as having a substantially trapezoidal cross-sectional shape, but other shapes may be used without departing from the scope of the present invention. For example, the cavity 89 may have a semi-circular shape, a tapered triangular shape with a relatively small radius of curvature at a distal end thereof, a tapered triangular shape with a relatively large radius of curvature at a distal end thereof, or an oblique angled shape, as non-limiting examples. The cavity 89 is configured to receive at least a portion of the sealing element 60 therein during compression of the sealing element 60 between the first block 10 and the second block 40.

The first seal engaging surface 86 may include any number of the engaging beads 88 and any number of the cavities 89, as desired. In some embodiments, the first seal engaging surface 86 includes a plurality of the engaging beads 88 interposed in alternating fashion between each of the cavities 89 with respect to the radial direction, as desired. Any suitable configuration of the engaging beads 88 and the cavities 89 may be used without departing from the scope of the present invention.

The second block 40 includes a main body having a substantially planar second mating face 44. The main body includes a second recess 54 indented axially from the second mating face 44 in a direction perpendicular thereto. The second recess 54 includes an axially extending inner circumferential surface 55 having an inner diameter substantially equal to and slightly greater than an outer diameter of the projecting portion 16 of the first block 10 and a second seal engaging surface 56 extending radially inwardly from the inner circumferential surface 55. An axially extending annular groove 59 is formed at the intersection of the inner circumferential surface 55 and the second seal engaging surface 56. The annular groove 59 is configured to receive the piloting feature 20 of the first block 10 therein.

The second seal engaging surface 56 extends radially inwardly from the annular groove 59 and terminates at a second opening 46 of the second block 40. The second opening 46 is cylindrical in shape and formed concentrically relative to the annularly extending second recess 54. The second opening 46 extends in the axial direction of the second recess 54, which is arranged perpendicular to the second mating face 44 of the second block 40. The second opening 46 extends through the second block 40 and is configured to convey the fluid therethrough. The second opening 46 may be configured to receive or otherwise engage a length of tubing or the like (not shown). Alternatively, the second block 40 may form a portion of a component of the associated fluid system and the second opening 46 may communicate the fluid directly to an operational portion of the component, as desired. The second opening 46 of the second block 40 is placed in concentric alignment with the first opening 30 of the first block 10 when the blocks 10, 40 are coupled to each other via the fastener assembly 70.

The second seal engaging surface 56 includes an engaging bead 58 formed intermediate the inner circumferential surface 55 and the second opening 46. The engaging bead 58 extends annularly adjacent the second opening 46 and is configured to sealingly engage at least a portion of the sealing element 60. The engaging bead 58 forms an axially extending projection or rib configured to impart a localized compressive stress on the portion of the sealing element 60 disposed within the recess 54.

The engaging bead 58 is shown in FIG. 1 as having a substantially V-shaped cross-sectional shape including a pointed edge formed at a distal end of the engaging bead 58. The edge may be formed by a pair of tapering surfaces arranged at an angle relative to each other. A sharpness of the edge of the engaging bead 58 may be selected to impart a desired degree of compressive stress to the portion of the sealing element 60. An angle formed between the cooperating surfaces may be selected to match the angle formed between the surfaces of the engaging bead 88 of the tube 80. One skilled in the art should appreciate that alternative configurations of the engaging bead 58 may be used without departing from the scope of the present invention so long as the engaging bead 58 is suitable for delivering the desired localized compressive stress to the portion of the sealing element 60 disposed within the second recess 54.

The second seal engaging surface 56 further includes at least one cavity 69 formed therein.

The at least one cavity 69 forms a depression in the second seal engaging surface 56 indented in a direction opposing the direction of projection of each of the engaging beads 58 of the second sealing surface 56. FIG. 1 illustrates the second seal engaging surface 56 as including a single annularly extending cavity 69 formed adjacent and outboard of the engaging bead 58. The cavity 69 is shown as having a substantially trapezoidal cross-sectional shape, but other shapes such as those described with reference to the cavity 89 of the tube 80 may also be used without departing from the scope of the present invention. The cavity 69 is configured to receive at least a portion of the sealing element 60 therein as is explained in greater detail hereinbelow.

The second seal engaging surface 56 may include any number of the engaging beads 58 and any number of the cavities 69, as desired. In some embodiments, the second seal engaging surface 56 includes a plurality of the engaging beads 58 interposed in alternating fashion between each of the cavities 69 with respect to the radial direction. The engaging beads 58 and the cavities 69 may be selected to in each case be in radial alignment with corresponding ones of the engaging beads 88 and the cavities 89 of the tube 80, as desired. Any suitable configuration of the engaging beads 58 and the cavities 69 may be used without departing from the scope of the present invention.

The second block 40 further includes a second fastener aperture 48 spaced apart from and arranged in parallel to the second opening 46. The second fastener aperture 48 is substantially cylindrical in shape and may include a threaded inner surface configured to cooperate with the threads formed on the corresponding threaded fastener 72. As should be understood, the second fastening aperture 48 of the second block 40 is positioned in concentric alignment with the first fastening aperture 38 of the first block 10 during assembly of the block assembly 1.

The sealing element 60 includes a first seal portion 62 and a second seal portion 64. The first seal portion 62 is a substantially flat annular ring having a substantially rectangular cross-sectional shape. In the embodiment shown, the first seal portion 62 is produced from a metallic material such as aluminum, copper, or alloys thereof. The first seal portion 62 may be further coated with pure tin or tin allowed with copper, nickel, cobalt, zinc, indium, lead, or antimony, as non-limiting examples.

The second seal portion 64 extends radially outwardly from the outer peripheral edge of the first seal portion 62. An annular channel is formed in a radial inner portion of the second seal portion 64 to receive the outer edge of the first seal portion 62. The second seal portion 64 is fastened to the first seal portion 62 by any conventional fastening means such as vulcanizing, heat welding, press fitting, an adhesive, or a mechanical means of attachment, for example. In the embodiment shown, the second seal portion 64 is produced from an elastomer. It is understood that the second seal portion 64 may be produced from any conventional material such as nylon, viton, neoprene, PEEK, NBR, HNBR, EPDM, and PTFE, and related series thereof, as non-limiting examples.

The fastener assembly 70 includes the threaded fastener 72 and a nut 74. The threaded fastener 72 includes an outer surface having threads configured for engagement with the internally threaded surface of the second fastener aperture 48. The threaded fastener 72 may be a threaded stud as shown in FIG. 1. Alternatively, the threaded fastener 72 may be a bolt including a head configured to engage an outer face of one of the blocks 10, 40. The nut 74 is internally threaded and configured to engage the external threads of the threaded fastener 72.

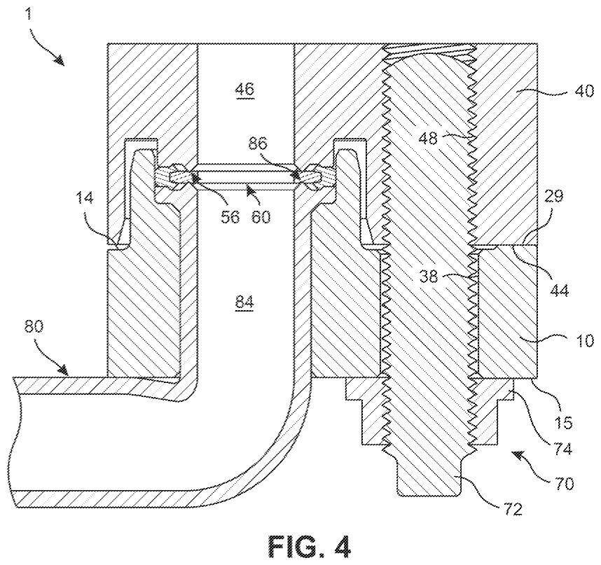

As shown in FIG. 4, the fastener assembly 70 is configured to urge the first block 10 towards the second block 40 to compress the sealing element 60 between the seal engaging surfaces 56, 86, thereby sealing a flow path formed by the cooperation of the tube 80 and the second opening 46 of the second block 10. First, the threaded fastener 72 is threaded into engagement with the internal threads of the second fastener aperture 48. Next, the nut 74 is rotated relative to the threaded fastener 72 to cause the nut 74 to move axially along the threaded fastener 72 until the nut 74 engages the outer face 15 of the first block 10. Continued rotation of the nut 74 causes a spacing present between the first mating face 14 of the first block 10 and the second mating face 44 of the second block 40 to decrease until the leverage feature 29 of the first block 10 contacts the second mating face 44 of the second block 40. The sealing element 60 is simultaneously compressed to a suitable degree between the first seal engaging surface 86 of the tube 80 and the second seal engaging surface 56 formed by the second block 40. Specifically, the engaging bead 88 and the engaging bead 58 are caused to approach and eventually engage the first seal portion 62 of the sealing element 60 from opposing axial directions, wherein continued urging of the first block 10 towards the second block 40 causes the engaging beads 58, 88 to impinge upon (penetrate) the exposed surfaces of the first seal portion 62 in a manner axially compressing the first seal portion 62 therebetween. The second seal portion 64, which is formed from an elastomer, is compressed between the blocks 10, 40 and is caused to elastically deform to conform to a space surrounding the second seal portion 64, thereby providing additional sealing at a position radially outward of the junction of the beads 58, 88 with the first seal portion 62. One skilled in the art should appreciate that any form of clamping feature suitable for urging the first block 10 towards the second block 40 in the manner described may be used without departing from the scope of the present invention.

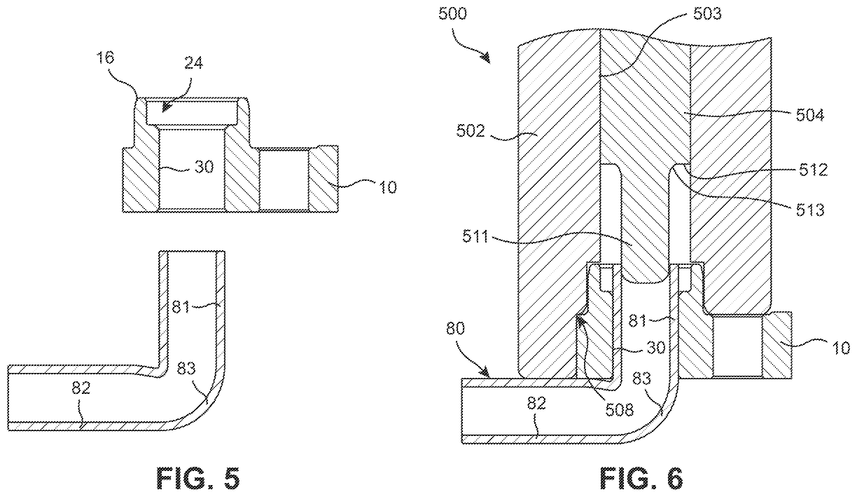

FIGS. 5-7 illustrate a method of manufacturing the block assembly 1 prior to formation of the first sealing surface 86, and more specifically, the steps required for forming the tube 80, coupling the tube 80 to the first block 10, and forming the end portion of the first segment 81 of the tube 80 into the seal engaging portion 85 thereof immediately prior to formation of the first sealing surface 86.

The tube 80 may originally be presented as a length of cylindrical tubing having a substantially constant inner diameter and outer diameter, as desired. In some embodiments, the tube 80 remains rectilinear in shape, and the tube 80 is not subjected to bending. In other embodiments, the tube 80 is bent using any conventional bending process or apparatus to divide the tube 80 into the first segment 81, the second segment 82, and the bend portion 83. The lift angle present between the first segment 81 and the second segment 82 may be selected in order to accommodate the packaging arrangement of the components adjacent the block assembly 1. If a purely rectilinear tube 80 is utilized, it should be understood that further references to the first segment 81 of the tube 80 hereinafter may alternatively correspond to a portion of the rectilinear tube 80 received through the opening 30 in the same fashion. Although not pictured, the tube 80 may also be provided to include a segment within the opening 30 having a greater thickness than a remainder of the tube 80 extending outside of the opening 30. The tube 80 may also be formed to include an axial stopping feature, such as including a radially outwardly extending bead at a position corresponding to a desired depth of the tube 80 within the opening 30. The tube 80 may be formed to include such features during an initial punching operation similar to those shown and described.

The first segment 81 of the tube 80 is received through the first opening 30 to cause an end portion of the first segment 81 to extend outside of the first opening 30 and into the first recess 24 formed by the projecting portion 16. If a bent tube is used, the second segment 82 may form a stopping feature for establishing an extent of axial insertion of the first segment 81 in the first opening 30 when the second segment 82 contacts the outer face 15 of the first block 10. Alternatively, as mentioned above, the first segment 81 or the bend portion 83 of the tube 80 may be further deformed to provide the stopping feature for establishing the extent of axial insertion of the first segment 81 within the first opening 30 without departing from the scope of the present invention.

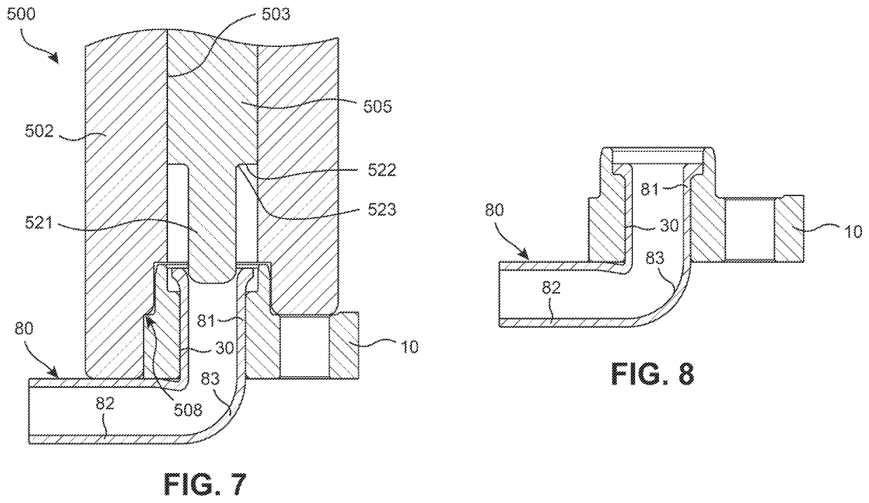

Following reception of the first segment 81 in the first opening 30 as shown in FIG. 6, the end portion of the first segment 81 extending outside of the first opening 30 is then deformed radially outwardly to form an outwardly extending flange of the first segment 81. The outward deformation of the end portion of the first segment 81 may require multiple deformation steps. For example, FIGS. 6 and 7 show two independent deforming steps for forming the end portion of the first segment 81 into the shape and configuration shown in FIG. 8.

The deforming steps may be performed using a tube end forming apparatus as is known in the art, such as a ram type apparatus including a tool configured for axial reception into or around the end portion of a corresponding tube, wherein a “ramming” of the tool into or around the corresponding tube causes the deformation of the tube.

FIGS. 6 and 7 illustrate one exemplary tube end forming apparatus 500 suitable for performing the desired deformation of the end portion of the first segment 81. The apparatus 500 includes a holding structure 502 and one of a pair of ram tools 504, 505. FIG. 6 illustrates a first ram tool 504 suitable for performing the first deforming step while FIG. 7 illustrates a second ram tool 505 having a different structure for performing the second deforming step. Although described as having a common holding structure 502, it should be apparent that the block assembly 1 may be manufactured via two distinct tooling assemblies with each of the tooling assemblies including an independently provided one of the holding structures 502, as opposed to utilizing two different ram tools 504, 505 with respect to a single holding structure 502. It should also be readily apparent to one skilled in the art that fewer or greater tools may be added to the process for deforming the tube 80 in the manner desired, such as replacing the deforming steps shown with respect to FIGS. 6 and 7 with fewer or greater incremental steps for arriving at the same general configuration of the tube 80 as shown in FIG. 8, as is necessary.

The holding structure 502 extends annularly and includes an axially extending tool opening 503 configured to slidably receive either of the ram tools 504, 505. A drive mechanism (not shown) of the apparatus 500 causes the corresponding ram tool 504, 505 to selectively reciprocate within the tool opening 503. The drive mechanism also applies an axial force to the corresponding ram tool 504, 505 suitable for deforming the rigid material forming the tube 80. The holding structure 502 further includes a block opening 508 at an end thereof having a shape and size corresponding to an outer surface of the first block 10. A surface of the holding structure 502 defining the block opening 508 accordingly engages the first block 10 and maintains a position and configuration of the first block 10 during each of the aforementioned deforming steps.

The first ram tool 504 includes a cylindrical and axially extending stem 511, an annular and radially extending surface 512 adjacent an end of the stem 511, and an annular and arcuate surface 513 connecting the stem 511 to the radially extending surface 512. As shown by a comparison of FIG. 6 to FIG. 7, the shape of the first ram tool 504 results in the end portion of the first segment 81 being flared radially outwardly in accordance with the shape of the first ram tool 504 when the first ram tool 504 is axially inserted into the first segment 81.

The second ram tool 505 includes a cylindrical and axially extending stem 521, an annular and radially extending surface 522 extending radially outwardly from a base of the stem 521, and an annular and arcuate surface 523 connecting the stem 521 to the radially extending surface 522. As can be seen by comparison of FIG. 7 to FIG. 8, the shape of the second ram tool 505 results in the end portion of the first segment 81 being further deformed radially outwardly to cause the end portion of the first segment 81 to conform in shape to the corresponding portions of the outer surface of the first block 10 while an axial end of the first segment 81 is arranged substantially planar and perpendicular to the axial direction of the first segment 81.

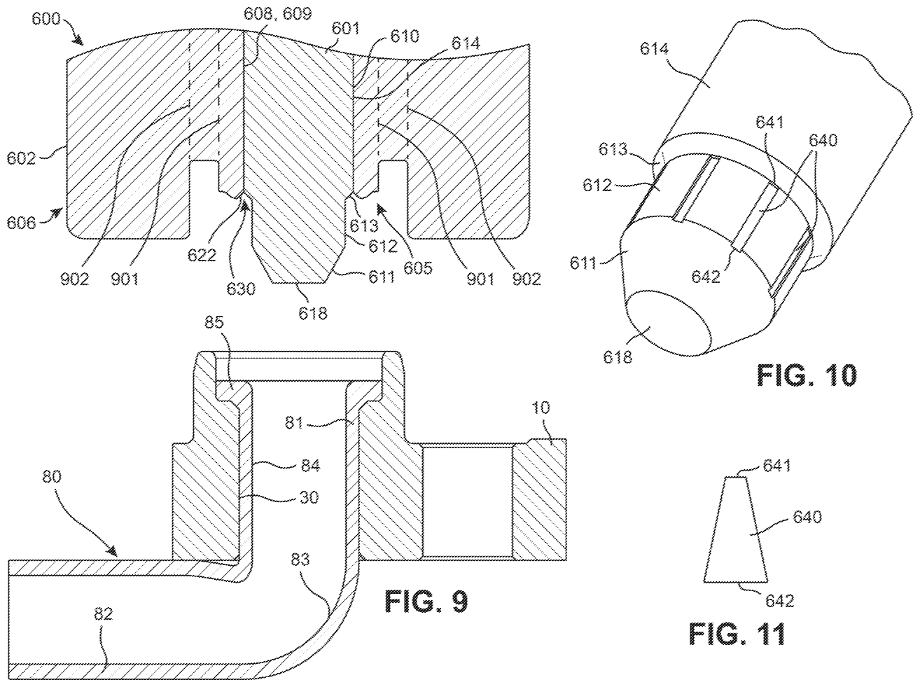

Referring now to FIG. 9, a method and apparatus for forming the first sealing surface 86 into the seal engaging portion 85 once the assembly has reached the configuration of FIG. 8 is disclosed. It should be understood that the steps disclosed hereinafter may occur with respect to alternative manufacturing processes utilized in arriving at the configuration of FIG. 8 while remaining within the scope of the present invention. That is, the method of forming a V-shaped bead 88 having a minimized radius of curvature within the first sealing surface 86 as disclosed hereinafter may be applied to the seal engaging portion 85 regardless of the method of forming and flanging the tube 80 into the necessary configuration for use with the disclosed apparatus.

FIG. 9 illustrates a tube end forming apparatus 600 suitable for performing the desired deformation of the end portion of the tube 80 for forming the first sealing surface 86 therein. The tube end forming apparatus 600 may be described as performing a “coining” operation, wherein the term “coining” is synonymous with forging, stamping, impacting, punching, or drawing, wherein axial force is applied in order to deform a desired surface of the corresponding workpiece.

The apparatus 600 includes a first ram tool portion 601 and a second ram tool portion 602.

The first ram tool portion 601 forms an inner portion of the apparatus 600 while the second ram tool portion 602 forms an outer portion of the apparatus 600. The first ram tool portion 601 may alternatively be referred to as the inner portion 601 of the apparatus 600 while the second ram tool portion 602 may alternatively be referred to as the outer portion 602 of the apparatus 600. The inner portion 601 is received within the outer portion 602 with the portions 601, 602 arranged concentrically relative to each other. The inner portion 601 and the outer portion 602 may each include axially symmetric shapes with respect to the surfaces of the portions 601, 602 configured to engage the seal engaging portion 85 of the tube 80 when deforming the tube 80 as described hereinafter. In the present embodiment, the inner portion 601 is a substantially cylindrically shaped stem while the outer portion 602 is a substantially cylindrically shaped collar.

The outer portion 602 includes a surface forming portion 605 arranged along a radially inward segment of the outer portion 602 adjacent the inner portion 601 and a holding portion 606 disposed radially outwardly of the surface forming portion 605. The holding portion 606 is configured to surround and hold the block 10 having the tube 80 while the surface forming portion 605 is configured to engage and deform the seal engaging portion 85 of the tube 80 during formation of the first sealing surface 86.

The inner portion 601 includes an outer circumferential surface 610 including a tapered surface 611 intersecting an end 618 of the inner portion 601 and having a frustoconical shape, an axially extending surface 612 having a cylindrical shape disposed adjacent the tapered surface 611, a first bead forming surface 613 that is tapered to include a frustoconical shape adjacent the axially extending surface 612, and another axially extending surface 614 having a cylindrical shape disposed adjacent the first bead forming surface 613.

The surface forming portion 605 of the outer portion 602 includes a second bead forming surface 622 facing towards the first bead forming surface 613 of the inner portion 601. That is, the first bead forming surface 613 is inclined to face outwardly away from a central axis of the inner portion 601 while the second bead forming surface 622 is inclined to face inwardly towards the central axis of the inner portion 601. The second bead forming surface 622 is tapered to include a frustoconical shape. The first bead forming surface 613 and the second bead forming surface 622 include opposite tapers to result in the formation of a V-shape via the cooperation of the surfaces 613, 622. That is, the first bead forming surface 613 extends in a first axial direction of the tube 80 when progressing in the radial outward direction thereof while the second bead forming surface 622 extends in an opposing second axial direction of the tube 80 when continuing to progress in the radial outward direction thereof beyond the first bead forming surface 613. The bead forming surfaces 613, 622 may have any desired inclinations relative to the axial direction of the tube 80, as desired, including equal and opposing inclinations. As mentioned above, it is conceivable that the bead forming surfaces 613, 622 may include differing inclinations, as desired, without necessarily departing from the scope of the present invention.

The outer portion 602 includes an inner circumferential surface having an axially extending surface 608 defining an opening 609 for receiving the inner portion 601 therein. The second bead forming surface 622 forms a portion of the inner circumferential surface and tapers radially outwardly away from a central axis of the inner portion 601 as the second bead forming surface 622 extends axially away from an intersection of the second bead forming surface 622 and the axially extending surface 608. The axially extending surface 614 of the inner portion 601 faces towards the axially extending surface 608 of the outer portion 602 and an annular gap 630 is formed therebetween, wherein the gap 630 is present between the inner and outer portions 601, 602 with respect to the radial direction of the apparatus 600. The gap 630 extends axially from an end of each of the bead forming surfaces 613, 622 at the pointed end of the V-shape formed thereby. The gap 630 is fluidly coupled to a space disposed exterior to the apparatus 600, thereby allowing for any substances entering the gap 630 to be vented or otherwise removed from the gap 630. The gap 630 is most easily seen in the enlarged fragmentary views of FIGS. 12-14.

The apparatus 600 differs from the apparatus 500 in that the outer portion 602 doubles as the holding structure and one of the ram tools, as opposed to having a dedicated holding structure 502 that does not directly deform the tube 80. However, it should be readily apparent to one skilled in the art that the structure described as forming the surface forming portion 605 of the outer portion 602 may be adapted for reception within a holding structure such as the holding structure 502 while remaining within the scope of the present invention, wherein the resulting apparatus includes the inner and outer portions 601, 602 moving relative to the holding structure 502 once the corresponding block has been secured by the holding structure 502 during a punching process. For example, FIG. 9 is shown as including a first set of axially extending dashed lines 901 disposed at a first radius from the central axis of the inner portion 601 as well as a second set of axially extending dashed lines 902 disposed at a second radius from the central axis of the inner portion 601. Each of the sets of the dashed lines 901, 902 is representative of a possible division of the outer portion 602 into a distinct holding structure 606 and surface forming portion 605, which are able to move axially independently of one another. Specifically, each set of the dashed lines 901, 902 is representative of the position of a potential cylindrical opening formed within the outer disposed holding structure 606, which in turn slidably receives the surface forming portion 605 therein at a radially inward position, which then further slidably receives the inner portion 601 therein at a central position. It can be seen that the division of the outer portion 602 into the distinct portions 605, 606 at the first set of dashed lines 901 results in the holding structure 606 having substantially the same structure as the holding structure 502. Such a configuration may accordingly result in the ability to utilize an assembly of the surface forming portion 605 disposed inwardly of the first set of the lines 901 and the inner portion 601 as another tool suitable for use with the holding structure 502 utilized in the prior deforming steps, thereby reducing the tooling required in performing the assembly of the blocks.

Referring now to FIG. 10, the axially extending surface 612 of the inner portion 601 may include a plurality of circumferentially spaced relief notches 640 to allow for excess flow of the tube 80 to be directed to a portion of the resulting tube 80 that does not negatively affect the seal provided by the sealing surface 86. Each of the relief notches 640 is provided to increase a radial distance the gap 630 extends at each of the circumferential positions of one of the relied notches 640. The relief notches 640 are shown as including a rectangular perimeter shape that is indented radially inwardly into the axially extending surface 612, but alternative shapes may be utilized while remaining within the scope of the present invention. For example, each of the relief notches 640 may instead include a tapered trapezoidal shape to facilitate removal of the inner portion 601 from the tube 80 in the absence of excessive friction therebetween as may be produced by purely axially extending surface engagement. FIG. 11 illustrates one exemplary shape for a trapezoidal shaped relief notch 640 having a first end 641 that is wider circumferentially than a second end 642 thereof, wherein the first end 641 represents the axial end of the relief notch 640 formed at the intersection of the surfaces 611, 612 while the second end 642 represents the axial end of the relief notch 640 formed at the intersection of the surfaces 612, 613. Any number of the relief notches 640 may be utilized, such as two or more, and as many as 100, as a non-limiting example. The relief notches 640 may be provided to include an aspect ratio (width to punch OD) in the range of 1:2 to 1:50.

As shown in the enlarged views of FIGS. 12-14, operation of the apparatus 600 includes each of the inner portion 601 and the outer portion 602 being moved axially towards the seal engaging portion 85 of the tube 80 until a compressive load is applied thereto with respect to the axial direction of movement of each of the portions 601, 602. The portions 601, 602 continue to move axially to deform the seal engaging portion 85 into the illustrated shape of the first sealing surface 86 including the engaging bead 88 having the V-shaped cross-section. The first bead forming surface 613 forms a first inclined surface 93 of the engaging bead 88 while the second bead forming surface 622 forms the opposing second inclined surface 94 of the engaging bead 88. The inclined surfaces 93, 94 meet at a pointed end 95 of the engaging bead 88, which preferably includes a minimized radius of curvature corresponding to a maximized sharpness of the pointed end 95. The pointed end 95 of the engaging bead 88 is formed at the position of the radial gap 630. Any oil and/or gas disposed between the apparatus 600 and the seal engaging portion 85 is able to vent through the gap 630 to prevent entrapment along the first sealing surface 86.

FIGS. 12-14 illustrate one exemplary sequence wherein the outer portion 602 engages and deforms the seal engaging portion 85 of the tube 80 prior to the inner portion 601 engaging and deforming the seal engaging portion 85. However, another exemplary sequence (not shown) may include the inner portion 601 engaging and deforming the seal engaging portion 85 of the tube 80 prior to the second portion 602 engaging and deforming the sealing engaging portion 85, as desired. The operation of the apparatus 600 may include the portions 601, 602 moving in the axial direction to contact the seal engaging portion 85 of the tube 80 at the described different times to cause the opposing surfaces 93, 94 of the engaging bead 88 to be formed in sequential order, thereby allowing for the material forming the engaging bead 88 to “flow” towards the gap 630 from two opposing radial directions at different instants, thereby aiding in forming a minimized radius of the pointed end 95 of the engaging bead 88.

The time that elapses between the inner portion 601 and the outer portion 602 engaging and deforming (coining) the tube 80 may vary from 1 millisecond to 10 seconds, as one non-limiting range, regardless of the selected order of engagement of the portions 601, 602 with the tube 80. The inner portion 601 and the outer portion 602 may be semi-rigidly connected to one another to facilitate the slight delay in contact between the different portions 601, 602, wherein the same drive mechanism may be driving the movement of both portions 601, 602 simultaneously. For example, the portions 601, 602 may be mechanically joined via a spring, threaded fastener(s), a wedge, a tapered pin, or other tool or component for prescribing the different timing between the engagement of the portions 601, 602 with the tube 80. Alternatively, each of the portions 601, 602 may be driven by an independent drive mechanism to control the timing of each punch of each of the portions 601, 602, as desired. It should be apparent to one skilled in the art that the same effects of the portions 601, 602 on the tube 80 may be achievable regardless of the mechanism or control method utilized in determining any offset in timing between the strokes of the portions 601, 602, or any order of operation of the strokes of the portions 601, 602, hence any such mechanisms allowing for such an offset are within the scope of the present invention.

The example shown via comparison of FIGS. 12-14 may include the following sequence of events. First, the outer portion 602 begins to move axially towards the first block 10 and the tube 80 with an inner circumferential surface of the holding portion 606 of the outer portion 602 configured to be axially aligned with an outer circumferential surface of the projecting portion 16 of the first block 10 to properly position each feature of the first block 10 and the tube 80 received therein relative to the inner and outer portions 601, 602 of the apparatus 600. The piloting of the projecting portion 16 into the holding portion 606 occurs prior to the engagement of the seal forming portion 605 with the sealing engaging portion 85 of the tube 80.

Next, as the seal forming portion 605 of the outer portion 602 approaches the seal engaging portion 85 of the tube 80, the inner portion 601 may also be caused to begin moving axially towards the seal engaging portion 85 of the tube 80 in unison with the outer portion 602. As mentioned above, this timing may be achieved by configuring the mechanism coupling the inner and outer portions 601, 602 to prescribe the sequence of the axial movement of each respective portion 601, 602 during a common driving of the assembly of the portions 601, 602 by a common drive mechanism. As shown in FIG. 13, the prescribed timing may include the axially extending surface 612 of the inner portion 601 being received within the flow opening 84 of the tube 80 prior to the seal forming portion 605 making contact with the seal engaging portion 85 of the tube 80 during the simultaneous movement of the inner and outer portions 601, 602. This reception of the inner portion 601 in the tube 80 may be utilized to stabilize the inner diameter of tube 80 along the flow opening 84 thereof during the deformation of the seal engaging portion 85 via the seal forming portion 605 of the outer portion 602. However, the method may alternatively be practiced absent the axial insertion of the axially extending surface 612 within the flow opening 84 of the tube 80, as desired, without necessarily departing from the scope of the present invention.

The engagement of the seal forming portion 605 with the seal engaging portion 85 of the tube 80 includes the second bead forming surface 622 of the outer portion 602 forming the second inclined surface 94 of the engaging bead 88. Specifically, as the second bead forming surface 622 engages the seal engaging portion 85 and applies an axial load thereto, the seal engaging portion 85 is compressed axially such that material may be caused to flow along the frustoconical surface formed by the second bead forming surface 622 as the shape of the seal engaging portion 85 is reconfigured by the coining process. The inclusion of the gap 630 at the specified position provides a pathway for the compressed material to flow radially inwardly towards the resulting pointed end 95 of the engaging bead 88 due to the open space provided by the gap 630, as opposed to the material flowing in a radial outward direction corresponding to additional compression of the seal engaging portion 85 at a position radially outward of the engaging bead 88. The material forming the tube 80 is accordingly caused to flow in a direction parallel to the inclination of the second bead forming surface 622 that is both radially inward and axially opposite the direction of movement of the second bead forming surface 622 towards the seal engaging portion 85. The described process accordingly allows for the flow of the material forming the engaging bead 88 towards the pointed end 95 thereof, despite the opposing direction of the coining process.

The engagement of the second bead forming surface 622 with the seal engaging portion 85 also allows for any other fluids disposed therebetween, such as any air or oil (or other lubricant) associated with the described manufacturing process, to be similarly displaced towards the gap 630 in the same manner. Specifically, the air, oil, or other fluid may be caused to flow towards the gap 630 while flowing in a direction parallel to the inclination of the second bead forming surface 622 that is both radially inward and axially opposite the direction of movement of the second bead forming surface 622 towards the seal engaging portion 85. The ability of the air, oil, or other fluid to exit the boundary between the second bead forming surface 622 and the seal engaging portion 85 prevents an impingement of the corresponding fluid(s) into the resulting seal engaging surface 86 due to the relatively high compressive loads required for performing the described coining operation. The fluid(s) can flow towards the gap 630 and then flow axially along the gap 630 away from the seal engaging portion 85. The flow of such fluid(s) occurs prior to the completion of the deformation of the second inclined surface 94 to ensure that the fluid(s) do not negatively affect the resulting configuration of the second inclined surface 94.

As shown in FIG. 13, which includes the outer portion 602 having already formed the second inclined surface 94, the delayed timing of the axial movement of the inner portion 601 may also result in the formation of enlarged flow space 660 that is axially aligned with the first bead forming surface 613 and continuous with the gap 630. The enlarged flow space 660 may provide an additional flow space for the material forming the tube 80 and any additional fluids such as the described air and/or oil to flow during the formation of the second inclined surface 94 of the engaging bead 88.

As shown in FIG. 14, the continued axial movement of the inner portion 601 towards the seal engaging portion 85 eventually results in the first bead forming surface 613 engaging and deforming the seal engaging portion 85 in similar fashion to that described with respect to the second bead forming surface 622, but with a reversed radial direction of flow of any materials disposed at the boundary between the first bead forming surface 613 and the seal engaging portion 85 during the formation of the first inclined surface 93. Specifically, the inclusion of the gap 630 at the specified position provides a pathway for the compressed material of the tube 80 to flow radially outwardly towards the resulting pointed end 95 of the engaging bead 88 due to the open space provided by the gap 630, as opposed to the material flowing in a radial inward direction corresponding to additional compression of the seal engaging portion 85 at a position where the tube 80 engages the axially extending surface 612 of the inner portion 601. The material is accordingly caused to flow in a direction parallel to the inclination of the first bead forming surface 613 that is both radially outward and axially opposite the direction of movement of the first bead forming surface 613 towards the seal engaging portion 85. The described process accordingly allows for the flow of the material forming the engaging bead 88 towards the pointed end 95 thereof, despite the opposing direction of the coining process.

Similarly, any fluid(s) such as air, oil, or other lubricants disposed between the inner portion 601 and the tube 80 may be caused to flow towards the gap 630 while flowing in a direction parallel to the inclination of the first bead forming surface 613 that is both radially outward and axially opposite the direction of movement of the first bead forming surface 613 towards the seal engaging portion 85. The ability of the fluid(s) to exit the boundary between the first bead forming surface 613 and the seal engaging portion 85 prevents an impingement of the fluid(s) into the resulting seal engaging surface 86 due to the relatively high compressive loads required for performing the described coining operation. The fluid(s) can instead flow towards the gap 630 and then flow axially along the gap 630 away from the seal engaging portion 85. The flow of such fluid(s) occurs prior to the completion of the deformation of the first inclined surface 93 to ensure that the fluid(s) do not negatively affect the resulting configuration of the first inclined surface 93.

The process of forming the engaging bead 88 also results in the formation of any remaining features present within the seal engaging surface 86, such as one of the cavities 89 described herein. The relief notches 640 formed within the inner portion 601 may also be configured to receive any excess material of the tube 80 therein during either of the coining steps applied with respect to either of the portions 601, 602. The relief notches 640 are provided at positions along the inner portion 601 wherein such excess material will form a circumferential pattern of circumferentially spaced and radially inwardly extending projections around the flow opening 84 adjacent the seal engaging portion 85 of the tube 80, wherein such projections include a relatively small flow profile having a negligible effect on the flow of a corresponding fluid through the block fitting 1.

The described method may be completed by removing each of the portions 601, 602 from the assembly of the first block 10 and the tube 80 in the opposing axial direction following the formation of the seal engaging surface 86. The first block 10 and the tube 80 are accordingly formed to include the same general configuration as that disclosed in FIG. 1, which allows for the assembly of the first block 10 and the tube 80 to be utilized in the block fitting assembly 1 of FIG. 4.

As mentioned previously, the described order of the engagement of the bead forming surfaces 613, 622 may be reversed without altering the manner in which the pointed end 95 of the engaging bead 88 is formed. For example, the inner portion 601 may be caused to move axially first such that the inner portion 601 is received within the tube 80 prior to the holding portion 606 of the outer portion 602 guiding the projecting portion 16 therein. The first bead forming surface 613 may form the first inclined surface 93 prior to the second bead forming surface 622 forming the second inclined surface 94. The formation of each surface 93, 94 may include the material forming the tube 80 flowing towards the gap 630 from each respective radial direction for forming an engaging bead 88 having the pointed end 95, and may further include the flow of any entrapped fluid(s) towards the gap 630 in the same manner.

Additionally, the division of the outer portion 602 into a distinct holding structure 606 and a distinct seal forming portion 605 (moveable relative to the holding structure 606) may include the formation of the engaging bead 88 in substantially similar fashion to that shown and described. The holding structure 606 may be caused to move axially prior to the seal forming portion 605 and/or the inner portion 601 to locate the first block 10 and the tube 80. Next, the seal forming portion 605 and the inner portion 601 may be moved axially towards the tube 80 in any of the described sequences for forming the engaging bead 88 in the manner described. Such a process may include the inner portion 601 received within the flow opening 84 of the tube 80 to stabilize the inner diameter of the tube 80 prior to either of the described deformations resulting in either of the inclined surfaces 93, 94.

As another variation, it is conceivable that some processes may include the simultaneous engagement of both of the bead forming surfaces 613, 622 with the tube engaging portion 85 such that the formation of each of the inclined surfaces 93, 94 includes the simultaneous flow of all corresponding materials and/or fluid(s) towards the gap 630, as desired.

The use of the apparatus 600 eliminates the need for a separate cutting tool as is traditionally utilized in forming such an engaging bead 88. The replacement of the cutting tool with the described process is able to occur because the described process results in a formation of an engaging bead 88 having a relatively sharp pointed end 95 suitable for use in conjunction with a corresponding sealing element 60 of the block assembly 1. That is, it has been discovered that the formation of the inclined surfaces 93, 94 of the engaging bead 88 via the independently provided first and second bead forming surfaces 613, 622 of the apparatus 600 promotes the deformation of the tube 80 towards the gap 630 in a manner wherein the resulting pointed end 95 has a reduced radius of curvature at the juncture of the inclined surfaces 93, 94 in comparison to a similar coining process utilizing a continuous V-shaped surface (absent a gap) corresponding to the desired shape of the resulting engaging bead 88. This occurs because all intervening fluid(s) are able to be removed from the apex of such a V-shape via the introduction of the gap 630, as opposed to such fluid(s) being trapped at the apex of such a V-shape in a manner preventing the flow of the material forming the tube 80 therein. This also occurs because the described configuration prescribes a desired flow direction of the material forming the tube 80 towards the intersection of each of the bead forming surfaces 613, 622 and each corresponding axially extending surface 608, 614 of one of the portions 601, 602, thereby promoting flow towards the apex of the V-shape for promoting an improved sharpness of the pointed end 95. The resulting configuration of the engaging bead 88 is accordingly advantageously more similar to that formed by such a cutting process while eliminating additional manufacturing steps and tooling assemblies associated with the use of such cutting processes.

It has also been surprisingly discovered that the process of deforming the tube 80 via the described coining process results in a work hardening of the material forming the tube 80 in comparison to the use of a cutting process for forming such an engaging bead 88. That is, the compression of the material forming the tube 80 at the seal engaging surface 86 results in a work hardening of the material forming the tube 80 along the seal engaging surface 86, which includes a work hardening of the material forming the tube 80 of at least a portion of the engaging bead 88. The material forming the engaging bead 88 of the tube 80 may be increased in hardness along at least the first inclined surface 93, the second inclined surface 94, and the surface forming the pointed end 95 of the engaging bead 88 connecting the inclined surfaces 93, 94. This increase in hardness is understood to refer to a change in a hardness of the material forming the tube 80 from prior to the deformation of the seal engaging portion 85 of the tube 80 to include the engaging bead 88 to after the deformation of the seal engaging portion 85 of the tube 80 to include the engaging bead 88, and specifically from before and after the formation of each of the respective surfaces 93, 94, 95 formed in the tube 80. A tube 80 having a seal engaging surface 86 and engaging bead 88 formed by the method disclosed herein is accordingly structurally distinct from a tube having an engaging bead formed by a traditional machining process wherein material is cut away or otherwise removed from the seal engaging portion to form the result V-shaped engaging bead into the seal engaging surface. The engaging bead 88 of the present invention is provided to include an increased hardness that cannot be achieved via such a traditional machining process.

The improvement in the hardness of the engaging bead 88 has been discovered to allow for a greater axial impingement (penetration) of the engaging bead 88 into the first seal portion 62 of the sealing element 60, which may be formed from a metallic material, in comparison to a similarly dimensioned engaging bead formed by such a cutting process, when exposed to similar circumstances. That is, a distance the engaging bead 88 is configured to axially penetrate the first seal portion 62 for a given axial load is greater for the punch-formed engaging bead 88 of the present invention than for an engaging bead formed by the described cutting or other machining process of the prior art, despite the ability to machine such a cut engaging bead to include a pointed end having a maximized sharpness (radius of curvature approaching zero). This increased impingement results in an increased sealing effect at the described junction.

The increased hardness of the engaging bead 88 also results in an improvement in the service life of the block fitting assembly 1 due to the manner in which the hardened surfaces can be utilized again following a disassembly and reassembly of the components forming the block fitting assembly 1. That is, the seal engaging surface 86 is not damaged by the process of engaging the tube 80 to the sealing element 60 as a result of the increased hardness of the tube 80 along the seal engaging surface 86, which facilitates the reengagement of the seal engaging surface 86 to the sealing element 60 (or a replacement sealing element 60) without compromising the integrity of the seal formed therebetween.

The radial dimension of the gap 630 present between the portions 601, 602 may be selected to impart the desired radius of curvature to the pointed end 95 of the V-shape of the engaging bead 88 while also allowing for the proper venting of the fluid(s) associated with the described manufacturing process. The radial dimension of the gap 630 may also be selected in accordance with a hardness of the material forming the tube 80 and/or the flow characteristics of the material forming the tube 80 during the described coining process.

It has been discovered that a reduction in the dimension of the gap 630 corresponds to a reduction in the radius of curvature at the pointed end 95 of the engaging bead 88. This is implied as the ends of the inclined surfaces 93, 94 intersecting the surface forming the pointed end 95 of the engaging bead 88 are brought closer together via such a reduction in the dimension of the gap 630. It has also been discovered that as the material forming the tube 80 is selected to be relatively softer (referring to the softness of the material prior to deformation thereof), the radius of curvature of the engaging bead 88 is also reduced to correspond to an increasing sharpness thereof. This is believed to occur as a result of the improved ability of the material forming the tube 80 to flow towards the pointed end 95 of the engaging bead 88 in the manner described herein.

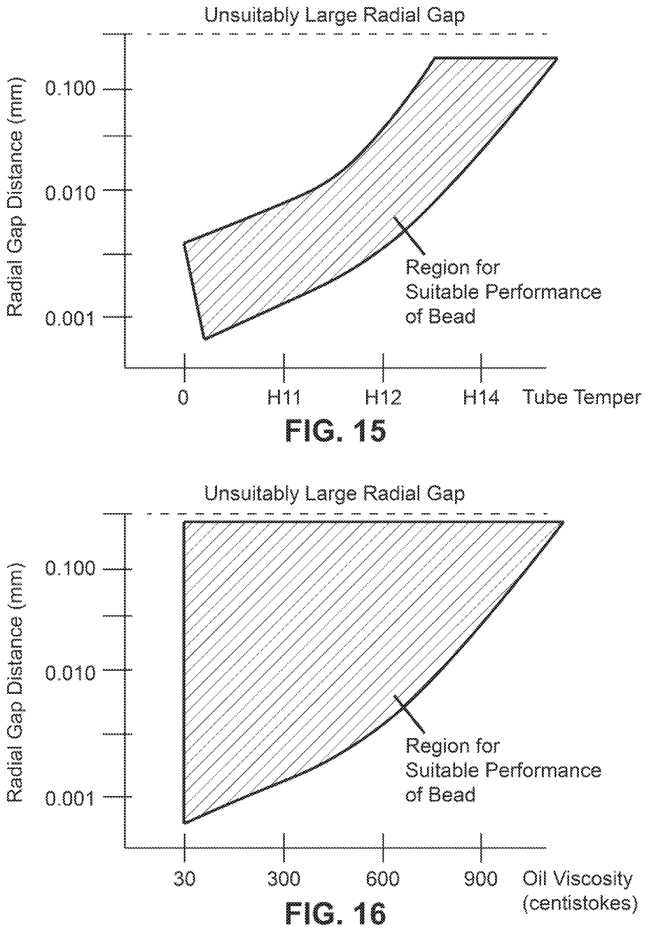

FIGS. 15 and 16 illustrate the relationships described hereinabove with reference to what is described as a region of “suitable” performance of the engaging bead 88 during use of the tube 80 with the block fitting assembly 1. The suitable performance referenced in the charts of FIGS. 15 and 16 corresponds to the formation of the engaging bead 88 to include a pointed end 95 having radius of curvature that is equal to or less than 0.2 mm. FIG. 15 illustrates a suitable range of selections of the dimension of the radial gap 630 for achieving the suitable engaging bead 88 with respect to a variety of different tube tempers corresponding to tubes of differing hardness. In contrast, FIG. 16 illustrates a suitable range of selections of the dimension of the radial gap 630 for achieving the suitable engaging bead 88 with respect to differing viscosities of an oil that may be disposed between the seal engaging portion 85 and the surfaces of the inner and outer portions 601, 602 of the apparatus 600. One non-limiting range of values suitable for the radial dimension of the gap 630 is between and including 0.001 mm and 0.25 mm.

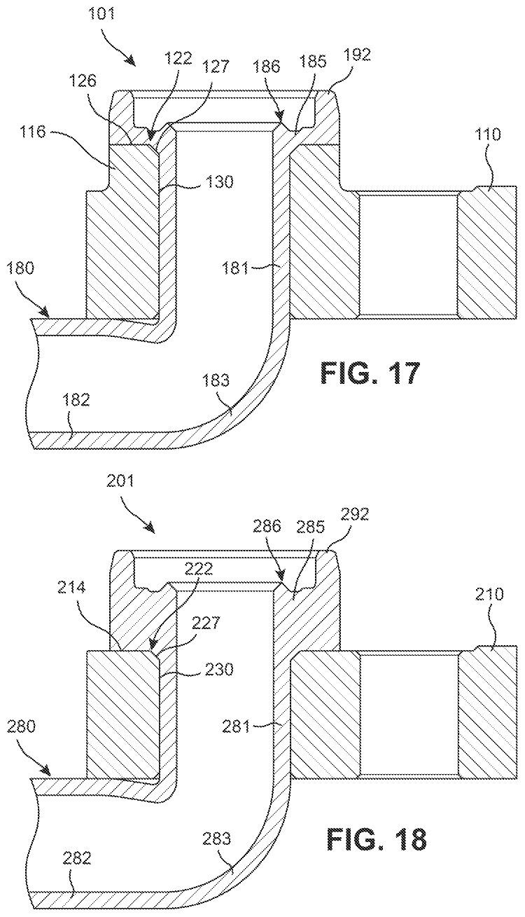

Referring now to FIG. 17, a block assembly 101 according to another embodiment of the invention is disclosed. The block assembly 101 includes a first block 110 and a tube 180 that are each modified in comparison to the first block 10 and the tube 80 of the block assembly 1. The second block 40, the sealing element 60, and the fastener assembly 70 of the seal fitting assembly 101 are identical to those disclosed with regards to the block assembly 1, hence further description is omitted.

The first block 110 includes an annular projection 116 surrounding and partially defining a first opening 130 of the first block 110. The projection 116 includes a shoulder 122 formed by the cooperation of a radially extending surface 126 of the projection 116 and a surface of the first block 110 defining the first opening 130. The shoulder 122 may further include a chamfer 127 providing an annular frustoconical surface at the intersection of the radially extending surface 126 and the surface defining the first opening 130.

The tube 180 may include a first segment 181, a second segment 182 angled relative to the first segment 181, and a bend portion 183 connecting the first segment 181 to the second segment 182 in similar fashion to the tube 80 of the block assembly 1. However, the tube 180 may alternatively be rectilinear in configuration without modifying the method disclosed hereinafter. The tube 180 is substantially identical to the tube 80 with the exception of a modification of an end portion of the first segment 181 configured to engage the projection 116 of the first block 110. The end portion of the first segment 181 is modified to define each of a seal engaging portion 185 and a piloting feature 192 of the first block 110. The seal engaging portion 185 extends radially outwardly to form a flanged portion of the tube 180 and the piloting portion 192 projects axially from a radial outermost portion of the seal engaging portion 185. The seal engaging portion 185 defines a seal engaging surface 186 of the tube 180 configured to engage the sealing element 60 when the first block 110 and the second block 40 are coupled to each other. The seal engaging surface 186 is disposed radially inwardly from the piloting feature 192 and includes each of the features described hereinabove with reference to the first seal engaging surface 86 of the tube 80 for applying the desired localized compressive forces to the sealing element 60. As shown by comparison of the block assembly 1 of FIG. 1 to the block assembly 101 of FIG. 17, the combination of the projection 116 and the tube 180 forms a male structural feature of the first block 110 having substantially the same shape and configuration as a male structural feature of the first block 10 formed by the combination of the projecting portion 16 and the tube 80.

The block assembly 101 operates in similar fashion to the block assembly 1. The first block 110 is drawn towards the second block 40 via use of the fastener assembly 70 to compress the sealing element 60 between the seal engaging surface 186 formed by the tube 180 and the seal engaging surface 56 formed by the second block 40.

The block assembly 101 is also manufactured using substantially the same process as described hereinabove with reference to the block assembly 1, except the formation of the piloting feature 192 in addition to the seal engaging portion 185 may require additional deforming and machining processes to be performed on the end portion of the first segment 181 following reception of the first segment 181 within the first opening 130. Furthermore, a greater length of the end portion of the first segment 181 may extend outside of the first opening 130 to accommodate the additional material used to form the piloting feature 192 of the tube 180. The sealing surface 186 may be formed using the apparatus 600 as disclosed hereinabove, wherein the engaging bead(s) of the block assembly 101 are formed by the same process described hereinabove.

FIG. 18 illustrates a first block 210 and a tube 280 of a block seal fitting assembly 201 according to yet another embodiment of the invention, wherein the first block 210 and the tube 280 are once again configured to cooperate with the second block 40, the sealing element 60, and the fastener assembly 70 as previously disclosed with reference to the block assembly 1 of FIGS. 1 and 4.

The first block 210 includes a first opening 230 extending axially therethrough. A shoulder 222 is formed at an intersection of a surface defining the first opening 230 and a substantially planar face 214 of the first block 210. The shoulder 222 may further include a chamfer 227 providing an annular frustoconical surface at the intersection of the planar face 214 and the surface defining the first opening 230. The tube 280 may include a first segment 281, a second segment 282 angled relative to the first segment 281, and a bend portion 283 connecting the first segment 281 to the second segment 282 in similar fashion to the tube 180 of the block assembly 101. However, the tube 280 may alternatively be rectilinear in configuration without modifying the method disclosed hereinafter. An end portion of the first segment 281 is deformed radially outwardly to form each of a seal engaging portion 285 having a seal engaging surface 286 and an axially projecting piloting feature 292. The end portion of the first segment 281 is accordingly substantially similar to the end portion of the first segment 181 except for the increased axial length of the end portion of the tube 280 used to form the entirety of a projecting portion of the tube 280 for reception within the second recess 54 of the second block 40.

The tube 280 may once again be formed by substantially the same process as described with reference to the tubes 80, 180. However, as described with reference to the tube 180, the tube 280 may require a greater length of the first segment 281 thereof extended outside of the first opening 230 to accommodate the additional material used to form the projecting portion of the tube 280. Furthermore, it should be understood that additional deforming and machining steps may be required for forming the additional contours of the end portion of the tube 280, as desired. Again, the apparatus 600 may be used to form the sealing surface 286 in similar fashion to that described herein, and especially with regards to the formation of any engaging bead(s) present within the block assembly 201.

The block assemblies 101, 201 shown in FIGS. 17 and 18 are accordingly representative of alternative configurations of the flanged end portion of the tube that may be utilized in conjunction with the described configuration of the second block 40, where each of the alternative configurations maintains the use of a hardened engaging bead formed by the same coining process described herein with regards to the apparatus 600. One skilled in the art should also appreciate that the block assemblies 101, 201 may be adapted or modified to include any of the shown or described features described hereinabove with reference to the block assembly 1, as desired, without departing from the scope of the present invention.

The apparatus 600 is shown and described herein as including two portions 601, 602 that are concentrically arranged to form a single gap 630 corresponding to a single engaging bead 88, but it should be apparent that the general concepts of the invention may be repeated by repeating the disclosed structure with respect to the radial direction to introduce new and additional engaging beads. For example, a third concentric portion may be added with a second gap present between the second portion and the third portion in addition to a first gap present between the first and second portions. Each gap may correspond to the position of one of the pointed ends of one of the engaging beads. This structure can be repeated to form any number of concentrically arranged engaging beads as is desired.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A block seal fitting assembly comprising:
a first block having a first opening formed therethrough;
a sealing element; and
a tube extending through the first opening of the first block, an end portion of the tube forming a seal engaging surface of the tube configured to sealingly engage the sealing element, the seal engaging surface including an annular engaging bead projecting axially therefrom, the engaging bead extending around a flow opening formed through the tube at the end portion thereof, wherein at least a portion of the engaging bead is work hardened by a coining process used to form the engaging bead in the end portion of the tube.

2. The block seal fitting assembly of claim 1, wherein the coining process includes a compression of the material forming the tube to result in the at least the portion of the engaging bead being work hardened.

3. The block seal fitting assembly of claim 1, wherein the engaging bead includes a first inclined surface facing towards the flow opening of the tube, a second inclined surface facing away from the flow opening of the tube, and a pointed end having a surface connecting the first inclined surface to the second inclined surface.

4. The block seal fitting assembly of claim 3, wherein the at least the portion of the engaging bead that is work hardened by the coining process includes at least one of the first inclined surface thereof, the second inclined surface thereof, and the surface at the point end.

5. The block seal fitting assembly of claim 3, wherein the first inclined surface is formed by a first bead forming surface deforming the end portion of the tube and the second inclined surface is formed by a second bead forming surface deforming the end portion of the tube, and wherein the forming of the first inclined surface includes at least a portion of the tube deforming along the first bead forming surface towards the pointed end of the engaging bead and wherein the forming of the second inclined surface includes at least a portion of the tube deforming along the second bead forming surface towards the pointed end of the engaging bead.

6. The block seal fitting assembly of claim 3, wherein a radius of curvature of the surface formed at the pointed end of the engaging bead is less than or equal to 0.2 mm.

7. The block seal fitting assembly of claim 1, wherein the sealing element includes a first seal portion formed from a metallic material, and wherein the engaging bead is configured to at least partially penetrate the first seal portion when the seal engaging surface of the tube is sealingly engaging the sealing element.

8. A coining apparatus for forming an engaging bead in an end portion of a tube, the apparatus comprising:
an inner portion including an outer circumferential surface, the outer circumferential surface including a first outer axially extending surface and a first bead forming surface intersecting the first outer axially extending surface, wherein the first bead forming surface is tapered inwardly towards a central axis of the inner portion as the first bead forming surface extends away from the first outer axially extending surface, and wherein the inner portion is configured to be movable axially towards the end portion of the tube for forming a first inclined surface of the engaging bead via a deformation of the end portion of the tube by the first bead forming surface; and
an outer portion including an inner circumferential surface including an inner axially extending surface and a second bead forming surface intersecting the inner axially extending surface, wherein the first bead forming surface is tapered outwardly away from the central axis of the inner portion as the second bead forming surface extends away from the inner axially extending surface, and wherein the outer portion is configured to be movable axially towards the end portion of the tube for forming a second inclined surface of the engaging bead via a deformation of the end portion of the tube by the second bead forming surface;
wherein the first outer axially extending surface of the inner portion faces outwardly towards the inner axially extending surface of the outer portion with a radially extending gap present therebetween.

9. The coining apparatus of claim 8, wherein the radially extending gap is configured to vent a fluid disposed between the end portion of the tube and at least one of the first bead forming surface and/or the second bead forming surface.

10. The coining apparatus of claim 9, wherein the fluid is at least one of air and/or oil.

11. The coining apparatus of claim 8, wherein the radially extending gap is configured to receive a flow of the end portion of the tube therein when at least one of the first bead forming surface and/or the second bead forming surface is deforming the end portion of the tube.

12. The coining apparatus of claim 11, wherein a pointed end of the engaging bead is formed at a radial position of the radially extending gap.

13. The coining apparatus of claim 8, wherein an angle present between the first bead forming surface and the second bead forming surface is between 30 degrees and 120 degrees.

14. The coining apparatus of claim 8, wherein the inner portion further includes a second outer axially extending surface extending from the first bead forming surface, wherein the second outer axially extending surface is configured for reception within a flow opening of the tube when the inner portion moves axially towards the end portion of the tube.

15. The coining apparatus of claim 14, wherein the second outer axially extending surface includes a radially inwardly indented relief notch formed therein, the relief notch configured to receive a flow of the end portion of the tube therein during deformation thereof.

16. The coining apparatus of claim 8, wherein the inner axially extending surface and the first outer axially extending surface are each cylindrical in shape and wherein the first bead forming surface and the second bead forming surface are each frustoconical in shape.

17. A method of coining an engaging bead into an end portion of a tube, the method comprising the steps of:
providing a coining apparatus comprising:
an inner portion including an outer circumferential surface, the outer circumferential surface including a first outer axially extending surface and a first bead forming surface intersecting the first outer axially extending surface, wherein the first bead forming surface is tapered inwardly towards a central axis of the inner portion as the first bead forming surface extends away from the first outer axially extending surface; and
an outer portion including an inner circumferential surface including an inner axially extending surface and a second bead forming surface intersecting the inner axially extending surface, wherein the first bead forming surface is tapered outwardly away from the central axis of the inner portion as the second bead forming surface extends away from the inner axially extending surface;
wherein the first outer axially extending surface of the inner portion faces outwardly towards the inner axially extending surface of the outer portion with a radially extending gap present therebetween;
deforming the end portion of the tube to include a first inclined surface of the engaging bead when the inner portion is moved axially towards the end portion of the tube with the first bead forming surface engaging the end portion of the tube; and
deforming the end portion of the tube to include a second inclined surface of the engaging bead when the outer portion is moved axially towards the end portion of the tube with the second bead forming surface engaging the end portion of the tube.

18. The method of claim 18, further comprising a step of venting a fluid through the radial gap during at least one of the deforming of the end portion of the tube to include the first inclined surface of the engaging bead and/or the deforming of the end portion of the tube to include the second inclined surface of the engaging bead.

19. The method of claim 18, wherein the end portion of the tube flows towards the radial gap during at least one of the deforming of the end portion of the tube to include the first inclined surface of the engaging bead and/or the deforming of the end portion of the tube to include the second inclined surface of the engaging bead.

20. The method of claim 18, wherein a time offset is present between the steps of deforming the end portion of the tube to include the first inclined surface of the engaging bead and deforming the end portion of the tube to include the second inclined surface of the engaging bead.
